(19) United States
(12) Patent Application Publication
(10) Pub. No.: US 2012/0132816 A1
(43) Pub. Date: May 31, 2012

(54) METHOD TO PREPARE A SCINTILLATOR LAYER FOR APPLICATION ONTO A PHOTOSENSOR LAYER TO PRODUCE AN X-RAY DETECTOR OR ELEMENT THEREOF

(76) Inventors: Manfred FUCHS, Nuernberg (DE); Klaus LOWACK, Uttenreuth (DE); Adelbert PREISSLER, Uttenreuth (DE)

(21) Appl. No.: 13/301,854

(22) Filed: Nov. 22, 2011

(30) Foreign Application Priority Data
Nov. 26, 2010 (DE) 10 2010 062 033.5

(51) Int. Cl. G01T 1/20; C09J 7/02; B32B 38/10; B32B 33/00; B32B 37/14; B32B 37/12

(52) U.S. Cl. 250/369; 156/67; 428/41.7

(57) ABSTRACT

A scintillator layer is applied onto a photosensor layer to produce an x-ray detector or an x-ray detector element for imaging detection of ionizing radiation. The production process is improved by, in the production of the scintillator layer, an adhesive layer with a protective layer is applied onto the scintillator layer. This can occur layer by layer or a transfer adhesive tape that already includes the protective layer as a protective film can also be used.

### BACKGROUND OF THE INVENTION

1. Field of the Invention

The invention concerns a scintillator layer to apply a photosensor layer, x-ray detector or x-ray detector element for imaging detection of ionizing radiation that was produced with such a correspondingly prepared scintillator layer, a method to prepare such a scintillator layer for application onto a photosensor layer, and a method to produce an x-ray detector or x-ray detector element for imaging detection of ionizing radiation.

2. Description of the Prior Art

US 2008/0206917 A1 discloses a production process of a radiation detector for ionizing radiation in order to generate a graphical presentation of a radiated subject. After removal of a protective film, the adhesive layer is laminated onto a photosensor layer with the use of a transfer adhesive tape (having an adhesive layer and two protective films surrounding the adhesive layer). In the immediately following processing process, the second, still-remaining protective film is removed from the transfer adhesive tape or from the adhesive layer overlaying the photosensor layer, and the scintillator layer—under vacuum—is placed on the photosensor layer provided with an adhesive layer and glued thereto.

This procedure disclosed in US2008/0206917 A1 is very complicated, in particular due to the necessity of generating a vacuum. Moreover, in this method air inclusions (that, however, are still relatively small during the first gluing process) are significantly enlarged due to the action of the vacuum in the second gluing process.

### SUMMARY OF THE INVENTION

An object of the present invention is to provide an alternative production method for an x-ray detector or an x-ray detector element in which the combination of the scintillator layer and photosensor layer is simple to produce. In particular, the possibility should also be offered to produce the scintillator layer at a different location and to be able to transport it as necessary to the location of the installation of the complete sensor, thus the assembly of scintillator layer and photosensor layer.

The invention is based on the following considerations.

In the manufacture of detectors for graphical presentation of a subject with the use of ionizing radiation for medical applications or for NDT (Non-Destructive Testing), scintillators—for example Csl:Tl on Al substrates or GOS (Gadolinium oxysulfide=Gd₂O₂S) intensifier foils—are arranged over photosensors such as CMOS arrays or CCD arrays, in particular with amorphous silicon (a-Si) technology. The scintillator layer is either only pressed on or is glued. The gluing has the advantage that more light is injected from the scintillator into the photosensor.

Manufacturers of scintillators that simultaneously produce detectors glue the two components in a clean room environment. The same also applies for the manufacturer of detectors that obtain their scintillators from an OEM manufacturer. These manufacturers make at least random sample intake monitoring of the scintillators and then glue these onto the photosensors. Additional problems result for a manufacturer of scintillators that delivers its products to detector manufacturers without separate scintillator production. The scintillator layers—in particular the Csl layers—are very sensitive to humidity. For example, the needles in the scintillator layer dissolve, or the substrate corrodes, so the image quality becomes poorer. The present invention is based on the insight that it would be simpler in the manufacturing process (in particular for the detector manufacturer) if the adhesive layer were already located on the delivered scintillator layer, and this could be directly glued with the photosensor layer after removal of the protective film

According to the invention, the manufacturing process can thus be facilitated by applying to the scintillator layer, in the production of the scintillator layer, an adhesive layer with a protective layer. This can occur in layers, but a transfer adhesive tape can also be used for this which may already include the protective layer as a protective film. If a transfer adhesive tape with double protective film that surrounds the adhesive layer is used, a protective film is initially removed and the remaining transfer adhesive tape with the adhesive layer is glued onto the scintillator surface. In addition, in a second step an additional protective layer can thereby also be applied to the transfer adhesive tape, for example parylene and/or an inorganic protective layer, for example with TiO₂, Al₂O₃, SiO or SiNₓ. Alternatively, the transfer adhesive tape can also already be equipped with such an additional protective layer.

As used herein a scintillator layer is a known combination of a substrate with a scintillator material (Csl:Tl, for example) deposited on this, possibly with an additional protective layer, wherein the substrate side is always facing away from the adhesive layer. As used herein a photosensor layer is any layer structure, which generates electronic signals per pixel from operation signals.

The invention thus encompasses a scintillator layer prepared for application onto a photosensor layer for use in a detector for imaging detection of ionizing radiation, wherein the scintillator layer has an adhesive layer on at least one side, onto which adhesive layer is outwardly applied a removable protective layer (in particular a protective film) which is removed just before a gluing of the scintillator layer with a photosensor layer.

The scintillator layer can already be tested electro-optically after the application of the protective layer, i.e. before the assembly with the photosensor layer. A significant proportion of possibly expensive waste can hereby be avoided.

Furthermore, the invention encompasses an x-ray detector or an x-ray detector element for imaging detection of ionizing radiation which is manufactured in that a protective layer (in particular a protective film) is removed from a scintillator layer with protective layer applied on at least one side, and immediately following this the scintillator layer is glued with the light-sensitive side of a photosensor layer, with the adhesive layer being placed between the scintillator layer and the light-sensitive side of a photosensor layer.

In this x-ray detector or x-ray detector element according to the invention, the scintillator layer can also already be tested electro-optically with x-ray excitation before the gluing with the photosensor layer given an applied adhesive layer and protective layer.

In the aforementioned devices, the protective layer advantageously can be or is sealed with an additional, externally applied parylene layer.

Furthermore, a method for preparation of a scintillator layer—in particular a scintillator chip—for attachment to a photosensor layer includes the following method steps:
provision of the scintillator layer,
application of an adhesive layer onto at least one side of the scintillator layer,
application of a protective layer (in particular a protective film) onto the at least one adhesive layer.

Within the scope of the invention, a method to produce an x-ray detector or x-ray detector element for imaging detection of ionizing radiation includes the following method steps:
provision of the scintillator layer,
application of an adhesive layer onto at least one side of the scintillator layer, and
application of a protective layer (in particular a protective film) onto the at least one adhesive layer,
removal of the protective layer,
gluing of the scintillator layer with a photosensor layer.

The adhesive layer can be coated onto the scintillator layer or applied by serigraphy (silk-screening).

A paste-like or even liquid adhesive can particularly advantageously be applied.

It is particularly advantageous for the adhesive layer to be applied onto the scintillator layer with the use of a transfer adhesive tape, the transfer adhesive tape having at least one adhesive layer and a protective layer covering at least one side of the adhesive layer, or two protective layers covering the adhesive layer on both sides. If the transfer adhesive tape has protective layers on both sides, one of the protective layers must be removed before the application of the adhesive layer.

Moreover, the application of the adhesive layer and the protective layer can take place in one work step in that a transfer adhesive tape (comprising an adhesive layer and a protective layer) is applied with the adhesive layer onto the scintillator layer, and the protective layer remains on the adhesive layer until just before the gluing of the scintillator layer with the photosensor layer.

According to the invention, the transfer adhesive tape can be laminated, wherein at least one roller or a stationary blade can be used for this purpose.

Furthermore, an additional protective layer made of parylene and/or an additional protective layer made of inorganic material (which in particular comprises TiO₂ or Al₂O₃ or SiO or SiNₓ) can be applied onto the protective layer for an air- and water-tight seal.

### BRIEF DESCRIPTION OF THE DRAWINGS

FIG. 1 is a schematic presentation of an embodiment of a production method of a detector layer made of photosensor layer and scintillator layer, in accordance with the invention.

FIG. 2 is a schematic presentation of an alternative production method for a detector layer made up of photosensor layer and scintillator layer, using a transfer adhesive tape to apply an adhesive layer, in accordance with the invention.

### DESCRIPTION OF THE PREFERRED EMBODIMENTS

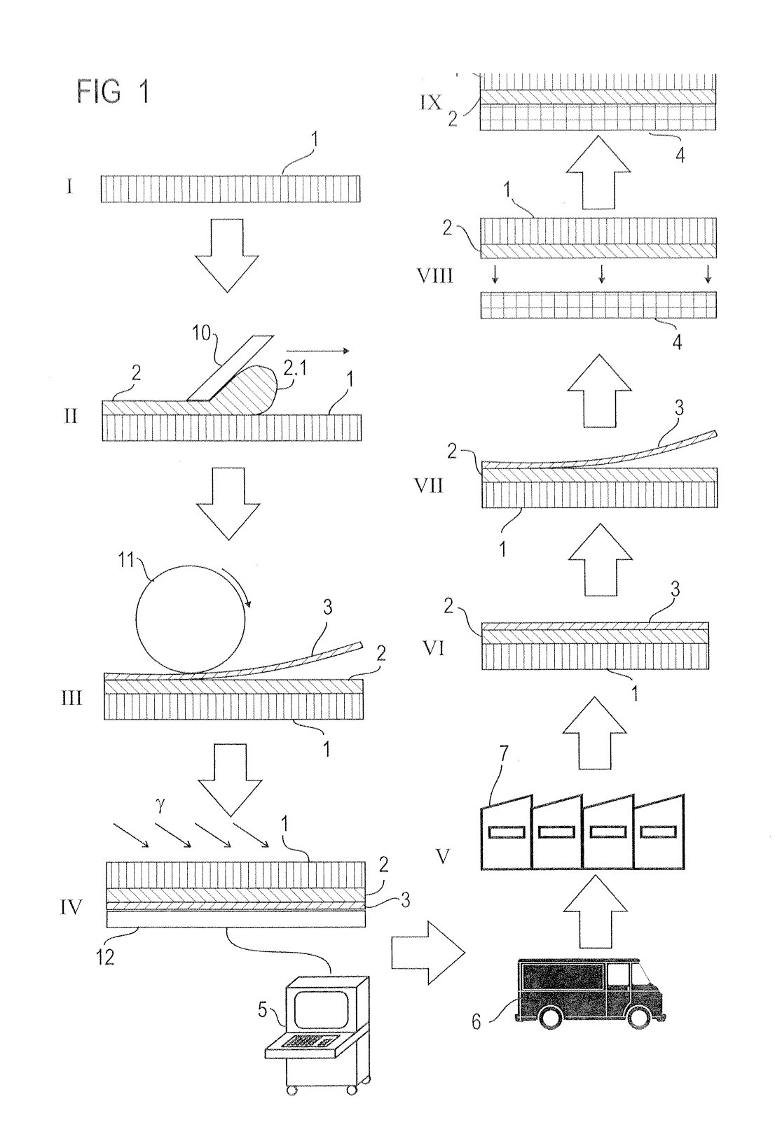

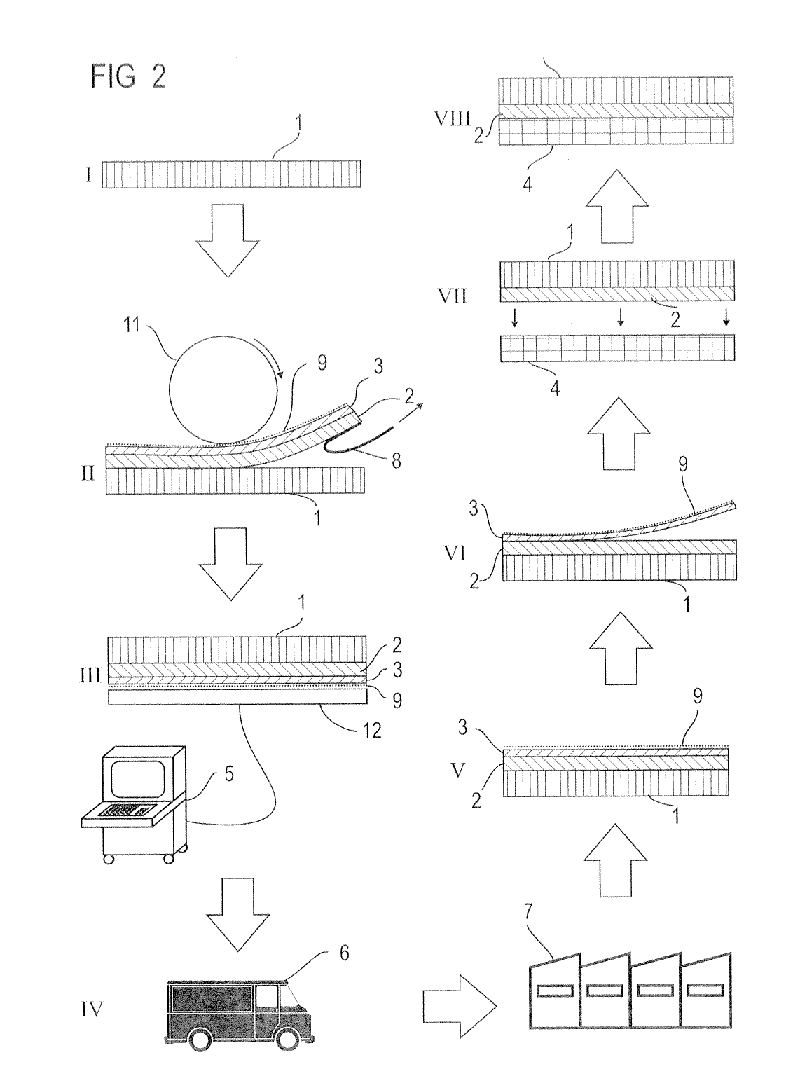

In the following the invention is described in detail with the use of FIGS. 1 and 2, wherein only the features required to understand the invention are shown. The following reference characters are used: 1: scintillator layer; 2: adhesive layer; 2.1: adhesive bead; 3: protective film/protective layer; 4: photosensor layer; 5: measurement elements; 6: transport means; 7: production device; 8: protective film/protective layer; 9: protective layer; 10: blade; 11: roller; 12: CCD chip (CCD=Charge Coupled Device=light-sensitive electronic component) or CMOS chip (CMOS=Complementary Metal Oxide Semiconductor); I through IX: method steps.

FIG. 1 schematically shows the individual method steps to produce a detector layer for an x-ray detector or for an x-ray detector element. In method step I a scintillator layer 1 is initially provided, in particular produced. In method step II an adhesive layer 2 is applied onto this scintillator layer 1 with the aid of a blade 10, in that an adhesive bead 2.1 is uniformly distributed over the surface of the scintillator layer 1, for example. A protective layer 3 is subsequently laminated onto the adhesive layer 2 (with the aid of a roller 11, for example) in method step III while avoiding air inclusions.

In method step IV the scintillator layer 1 can now optionally be monitored electro-optically with the aid of a CCD or CMOS chip 12—advantageously based on amorphous silicon (a-Si) technology—and corresponding medical instruments 5 with x-ray excitation. As an alternative to a directly placed CCD chip or CMOS chip, an electronic camera with corresponding optic and corresponding distance from the scintillator layer can also be used. It is hereby ensured that possible rejects can already be promptly removed from the production process.

For example, the scintillator layer 1 assembled in such a manner can be packaged and sent to an additional production device 7 in method step V with the aid of transport means 6.

In this production device 7 this preassembled scintillator layer 1 with the overlaid adhesive layer 2 and the protective layer 3 can now be removed from the packaging in method step VI. In method step VII the protective layer 3 is removed just before the additional processing. In method step VIII the scintillator layer 1 provided with an adhesive layer 2 is assembled and glued with a photosensor layer 4 so that a finished detector layer (comprising a scintillator layer 1, an adhesive layer 2 and a photosensor layer 4) is created in method step IX.

Another embodiment variant of the production process according to the invention is shown in FIG. 2. Here as well the scintillator layer 1 is produced or provided in the first method step I. In method step II an adhesive layer is subsequently applied onto the scintillator layer 1 with the aid of a transfer adhesive tape. For this a transfer adhesive tape is used which comprises an adhesive layer 2 that is arranged like a sandwich between a first protective film 3 and a second protective film 8. The protective film 8 is removed from the transfer adhesive tape just before the application of the adhesive layer 2, such that the adhesive layer 2 can be rolled onto the scintillator layer 1 (for example with the aid of a roller 11) while avoiding an air inclusion. The protective film 3 remains directly on the adhesive layer 2. This protective film 3 can additionally also be covered by an additional protective layer 9, which ensures that neither air nor water vapor can penetrate into the adhesive layer 2 or, respectively, to the scintillator layer 1.

A check of the scintillator layer 1 as described in FIG. 1 can now optionally take place in an additional method step III, so a possible reject can also be sorted out promptly at this time.

A transport with a transport means 6 to a production device 7 situated at a distance can optionally take place after this in method step IV, in which production device the preassembled scintillator layer 1 (corresponding to the statements made above) is removed from a packaging, and the protective film 3 with the additional overlaid protective layer 9 is removed just before the additional processing in method step VI, and in method step VII the scintillator layer 1 (with overlaid adhesive layer 2) prepared according to the invention is thereupon glued with a photosensor layer 4. The finished detector layer (comprising a scintillator layer 1, an adhesive layer 2 and a photosensor layer 4) for further processing as an x-ray detector or x-ray detector element then exists in method step VIII.

In total, a scintillator layer for application onto a photosensor layer; an x-ray detector or an x-ray detector element for imaging detection of ionizing radiation that was produced with a scintillator layer prepared according to the invention; a method to prepare such a scintillator layer for the application onto a photosensor layer; and a method to produce an x-ray detector or x-ray detector element for imaging detection of ionizing radiation are proposed with the invention, wherein according to the invention the production process is improved in that, in the production of the scintillator layer, an adhesive layer with a protective layer is applied onto this. This can occur layer by layer; a transfer adhesive tape which already comprises the protective layer as a protective film can also be used for this.

Although modifications and changes may be suggested by those skilled in the art, it is the intention of the inventors to embody within the patent warranted hereon all changes and modifications as reasonably and properly come within the scope of their contribution to the art.

We claim as our invention:

1. A scintillator prepared for application onto a photosensor layer for a detector or ionizing radiation for imaging, said scintillator layer comprising an adhesive layer on at least one side of said scintillator layer, said adhesive layer having a removable protective film thereon, said protective film being removed before gluing said scintillator layer to said photosensor layer.

2. A scintillator layer as claimed in claim 1 wherein said scintillator layer is electro-optically tested after application of said protective layer.

3. A scintillator layer as claimed in claim 1 comprising a parylene layer applied on said protective layer to seal said protective layer.

4. An x-ray detector or x-ray detector element for detecting ionizing radiation for imaging comprising a scintillator layer with an adhesive layer applied on at least one side thereof, said adhesive layer having a protective film that is removed therefrom before gluing the scintillator layer to a light-sensitive side of a photosensor layer, said adhesive layer being placed between the scintillator layer and the light-sensitive side of the photosensor layer.

5. An x-ray detector or x-ray detector element as claimed in claim 4 wherein said scintillator layer is electro-optically tested before gluing to said photosensor layer with the adhesive layer and protecting layer applied thereto.

6. An x-ray detector or x-ray detector element as claimed in claim 4 comprising a parylene layer applied on said protective layer to seal said protective layer.

7. A method for preparation of a scintillator layer for attachment to a photosensor layer, comprising:
applying an adhesive layer onto at least one side of the scintillator layer; and
applying a protective layer onto said at least one adhesive layer.

8. A method as claimed in claim 7 comprising coating said adhesive layer onto said scintillator layer.

9. A method as claimed in claim 7 comprising applying said adhesive layer onto said scintillator layer by serigraphy.

10. A method as claimed in claim 7 comprising employing said adhesive layer as a paste-like adhesive.

11. A method as claimed in claim 7 comprising applying said adhesive layer as a liquid adhesive.

12. A method as claimed in claim 7 comprising applying said adhesive layer using a transfer adhesive tape comprising the adhesive layer and a protective film covering the adhesive layer on at least one side thereof.

13. A method as claimed in claim 7 comprising applying the adhesive layer by applying a transfer adhesive tape comprising the adhesive layer having a protective film thereon at a side opposite to said scintillator layer, and retaining said protective film on said adhesive layer until immediately before gluing said scintillator layer onto the photosensor layer.

14. A method as claimed in claim 13 comprising laminating the transfer adhesive tape to the scintillator layer.

15. A method as claimed in claim 14 comprising laminating the adhesive tape using at least one roller.

16. A method as claimed in claim 15 comprising laminating the adhesive tape also using a stationary blade.

17. A method as claimed in claim 7 comprising applying a parylene layer onto said protective film.

18. A method as claimed in claim 7 comprising applying an additional protective layer onto said protective film, said additional protective layer being comprised of inorganic material selected from the group consisting of TiO₂, Al₂O₃, SiO, and SiNₓ.

19. A method to produce an x-ray detector or an x-ray detector element for ionizing radiation for imaging, comprising:
providing a scintillator layer;
applying an adhesive layer onto at least one side of the scintillator layer;
applying a protective film on a side of the adhesive layer facing away on said scintillator layer;
removing said protective film; and
gluing the scintillator layer to the photosensor layer with the adhesive layer.

20. A method for preparation of a scintillator layer for attachment to a photosensor layer, comprising:
applying an adhesive layer onto at least one side of the scintillator layer; and
applying a protective layer onto said at least one adhesive layer.

21. A method as claimed in claim 20 comprising coating said adhesive layer onto said scintillator layer.

22. A method as claimed in claim 20 comprising applying said adhesive layer onto said scintillator layer by serigraphy.

23. A method as claimed in claim 20 comprising employing said adhesive layer as a paste-like adhesive.

24. A method as claimed in claim 20 comprising applying said adhesive layer as a liquid adhesive.

25. A method as claimed in claim 24 comprising applying said adhesive layer using a transfer adhesive tape comprising the adhesive layer and a protective film covering the adhesive layer on at least one side thereof.

26. A method as claimed in claim 25 comprising applying the adhesive layer by applying a transfer adhesive tape comprising the adhesive layer having a protective film thereon at a side opposite to said scintillator layer, and retaining said protective film on said adhesive layer until immediately before gluing said scintillator layer onto the photosensor layer.

27. A method as claimed in claim 25 comprising laminating the transfer adhesive tape to the scintillator layer.

28. A method as claimed in claim 20 comprising laminating the adhesive tape using at least one roller.

29. A method as claimed in claim 20 comprising laminating the adhesive tape also using a stationary blade.

30. A method as claimed in claim 20 comprising applying a parylene layer onto said protective film.
